(19) United States
(12) Patent Application Publication
(10) Pub. No.: US 2014/0024352 A1
(43) Pub. Date: Jan. 23, 2014

(54) POSITIONING AND DIVERTING METHOD FOR MOBILE COMMUNICATION

(71) Applicants: Nen-Fu HUANG, Hsinchu (TW); Wei-Kuan SHIH, Hsinchu (TW)

(72) Inventors: Nen-Fu HUANG, Hsinchu (TW); Wei-Kuan SHIH, Hsinchu (TW)

(21) Appl. No.: 13/845,505

(22) Filed: Mar. 18, 2013

(30) Foreign Application Priority Data
Jul. 23, 2012 (TW) 101126442

(51) Int. Cl. H04W 4/16

(52) U.S. Cl. CPC H04W 4/16
USPC 455/417

(57) ABSTRACT

A positioning and diverting method for mobile communication as disclosed. The method includes the following steps of: providing a mobile communication end having a select interface including a plurality of positioning options, each corresponding to the location of a communication receiving end; selecting the positioning options by an input unit, so that the mobile communication end produces a setting signal corresponding to the positioning options; receiving the setting signal by a remote server, and the remote server has a database including a plurality of positioning data; comparing a plurality of positioning data and the setting signal to obtain at least one of the positioning data corresponding to the setting signal and to complete a divert setting by the remote server; and diverting a call signal transmitted by a communication calling end to the communication receiving end corresponding to the divert setting by the remote server.

### CROSS-REFERENCE TO RELATED APPLICATION

This application claims the benefit of Taiwan Patent Application No. 101126442, filed on Jul. 23, 2012, in the Taiwan Intellectual Property Office, the disclosure of which is incorporated herein in its entirety by reference.

### FIELD OF THE INVENTION

The present invention relates to a positioning and diverting method for mobile communication, and more particularly to the positioning and diverting method for mobile communication capable of selecting, receiving and diverting the position of a communication receiving end.

### BACKGROUND OF THE INVENTION

At present, telecommunication companies provide users to set their telephones with a function of diverting an incoming call. The users set a group of divert numbers and send the divert numbers to a telecommunications room of a telecommunication company, so that the telecommunication room controls the incoming calls dialed to a particular telephone number and diverts the calls to a preset divert number to facilitate users to receive the calls even when they go out or need to change a telecommunication device.

Therefore, the function of diverting an incoming call can be applied in different occasions such as going out, attending a meeting, being on a business trip or not in the office, and failing to pick up the call, and thus this function provides tremendous convenience to users. However, the function of diverting incoming calls still has the following drawbacks:

1. The setup procedure is complicated and cumbersome. The users have to set up the required input divert code and divert number for each time of setting the divert function. The users also need to input a cancel code to cancel the divert function.

2. The users have to pay the telephone fee for the divert section. For example, if a user divert incoming calls from a communication device at home to a designated mobile communication end, and someone makes a call to the communication device at home, then the call will be diverted to the designated mobile communication end. Once the call is connected, the user has to pay for the fee with regard to the divert call from the communication device at home to the mobile communication end.

3. After the user goes out and finds out that he/she has forgotten to set up the divert function, the user cannot receive the incoming calls dialed to the communication device at home.

In view of the aforementioned drawbacks, the inventor of the present invention provides a positioning and diverting method for mobile communication to overcome the drawbacks of the prior art and to improve industrial applications.

### SUMMARY OF THE INVENTION

Therefore, it is a primary objective of the present invention to provide a positioning and diverting method for mobile communication to overcome the cumbersome setting procedure.

To achieve the aforementioned objective, the present invention provides a positioning and diverting method for mobile communication, comprising the steps of: providing a mobile communication end having a selection interface, and the selection interface including a plurality of positioning options, each corresponding to the location of a communication receiving end; selecting at least one of the positioning options by an input unit to generate a setting signal corresponding to at least one of the positioning options; providing a remote server to receive the setting signal through network communication, and the remote server having a database containing a plurality of positioning data; comparing a plurality of positioning data with the setting signal by the remote server to obtain at least one of the positioning data corresponding to the setting signal and to complete a divert setting; and diverting a call signal transmitted by a communication calling end to the communication receiving end corresponding to the divert setting by the remote server.

Preferably, each positioning option includes the location of the communication receiving end, the number of communication receiving end, or a combination thereof.

Preferably, the setting signal includes a setting code, the number of the mobile communication end, the location of the communication receiving end, the number of the communication receiving end, or a combination thereof.

Preferably, the communication mode of the communication calling end and the communication receiving end is a telecommunication mode, a network communication mode, or a combination thereof.

Preferably, when the communication mode between the remote server, the communication calling end and the communication receiving end is the network communication mode, the positioning and diverting method for mobile communication further comprises the steps of: sending the call signal of the communication calling end to the remote server via the network communication mode; and diverting the call signal to the communication receiving end corresponding to the divert setting by the remote server according to the divert setting.

Preferably, when the communication mode of the communication receiving end is the telecommunication mode, and the communication mode between the mobile communication end, the remote server and the communication calling end is the network communication mode, the positioning and diverting method for mobile communication further comprises the steps of: sending the call signal of the communication calling end to the remote server via the network communication mode: sending the call signal to the mobile communication end by the remote server according to the communication mode of the communication receiving end; and generating an incoming message when the mobile communication end receives the call signal without answering the call.

Preferably, when the communication mode between the communication calling end, the communication receiving end and a telecommunication server is the telecommunication mode, and the communication between the mode mobile communication end and the remote server is the network communication mode, the positioning and diverting method for mobile communication further comprises the following steps: sending a setting information to the telecommunication server end by the remote server for the telecommunication server to complete a telecommunication divert setting; sending the call signal of the communication calling end the telecommunication server end via the telecommunication mode; and diverting the call signal to the communication receiving end corresponding to the telecommunication divert setting by the remote server according to the telecommunication divert setting.

Preferably, when the communication mode between the mobile communication end, a telecommunication server and the communication calling end is the telecommunication mode, and the communication mode between the mobile communication end, the remote server and the communication receiving end is the network communication mode, the positioning and diverting method for mobile communication further comprises the steps of: sending a setting information to the telecommunication server end by the remote server for the telecommunication server to complete a telecommunication divert setting; sending the call signal of the communication calling end to the telecommunication server end via the telecommunication mode; sending the call signal to the mobile communication end by the telecommunication server according to the communication mode of the communication receiving end; and generating an incoming message, when the mobile communication end receives the call signal without answering the call.

Preferably, the positioning and diverting method for mobile communication further comprises the steps of: providing a positioning unit to send a positioning signal to the mobile communication end; comparing the positioning signal with the plurality of positioning options through the mobile communication end to obtain one of the positioning options corresponding to the positioning signal and generate the setting signal corresponding to one of the positioning options; and receiving the setting signal by the remote server to complete the divert setting.

Preferably, the positioning and diverting method for mobile communication further comprises the steps of: providing the communication calling end to send the call signal to the remote server; diverting the call signal to the communication receiving end corresponding to the divert setting by the remote server; diverting the call signal to the mobile communication end by the remote server, when the communication receiving end receives the call signal without answering the call; and generating an incoming message when the mobile communication end receives the call signal without answering the call.

In summation, the positioning and diverting method for mobile communication in accordance with the present invention has one or more of the following advantages:

(1) The positioning and diverting method for mobile communication can select the location of the communication receiving end to complete the telecommunication divert setting via the remote server without the need of inputting input codes including the divert code and the divert number, so as to simplify the procedure of the telecommunication divert setting.

(2) The positioning and diverting method for mobile communication can divert the calls via network communication mode to save the telephone fee for diverting the call.

(3) The positioning and diverting method for mobile communication can obtain the communication receiving end for receiving and diverting the calls according to the positioning signal of the positioning unit in order to complete the diverting process. If a user has not carried the mobile communication end, the user still can set the divert function in order to use the communication receiving end to receive and listen to the incoming call dialed to the mobile communication end.

### BRIEF DESCRIPTION OF THE DRAWINGS

FIG. 1 is a first flow chart of a positioning and diverting method for mobile communication in accordance with a first preferred embodiment of the present invention;

FIG. 2 is a second flow chart of a positioning and diverting method for mobile communication in accordance with the first preferred embodiment of the present invention;

FIG. 3 is a schematic view of a positioning and diverting method for mobile communication in accordance with the present invention;

FIG. 4 is a flow chart of a positioning and diverting method for mobile communication in accordance with a second preferred embodiment of the present invention;

FIG. 5 is a flow chart of a positioning and diverting method for mobile communication in accordance with a third preferred embodiment of the present invention;

FIG. 6 is a flow chart of a positioning and diverting method for mobile communication in accordance with a fourth preferred embodiment of the present invention;

FIG. 7 is a flow chart of a positioning and diverting method for mobile communication in accordance with a fifth preferred embodiment of the present invention; and

FIG. 8 is a flow chart of a positioning and diverting method for mobile communication in accordance with a sixth preferred embodiment of the present invention.

### DESCRIPTION OF THE PREFERRED EMBODIMENTS

The technical characteristics, contents, advantages and effects of the present invention will be apparent with the detailed description of a preferred embodiment accompanied with related drawings as follows. The drawings are provided for the illustration, and same numerals are used to represent respective elements in the preferred embodiments. It is intended that the embodiments and drawings disclosed herein are to be considered illustrative rather than restrictive. Same numerals are used for representing same respective elements in the drawings.

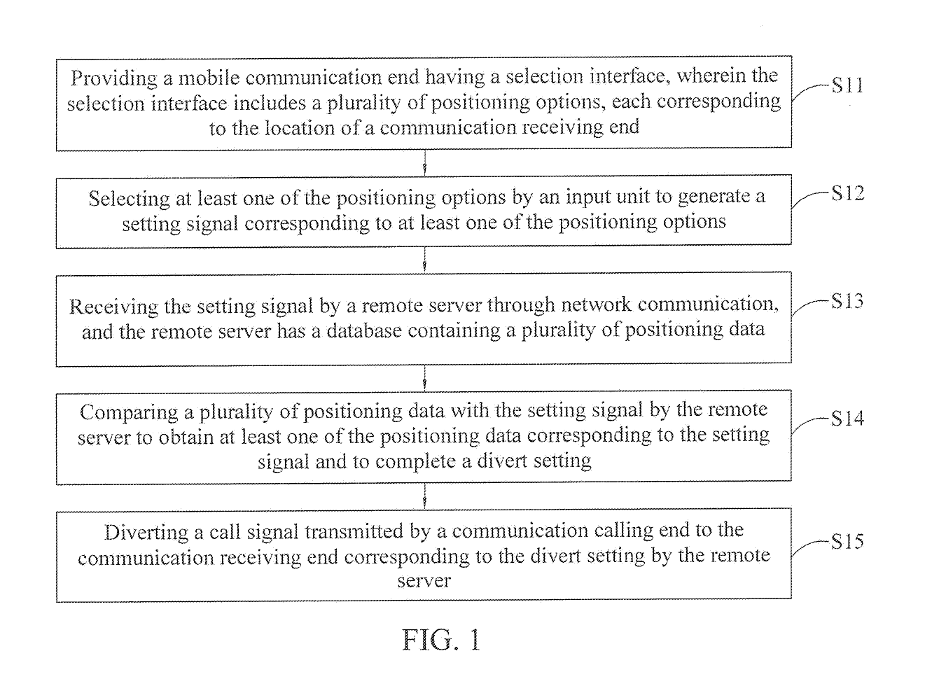

With reference to FIG. 1 for the first flow chart of a positioning and diverting method for mobile communication in accordance with the first preferred embodiment of the present invention, the positioning and diverting method for mobile communication comprises the following steps:

S11: Providing a mobile communication end having a selection interface, wherein the selection interface includes a plurality of positioning options, each corresponding to the location of a communication receiving end.

S12: Selecting at least one of the positioning options by an input unit to generate a setting signal corresponding to at least one of the positioning options.

S13: Receiving the setting signal by a remote server through network communication, and the remote server has a database containing a plurality of positioning data.

S14: Comparing a plurality of positioning data with the setting signal by the remote server to obtain at least one of the positioning data corresponding to the setting signal and to complete a divert setting.

S15: Diverting a call signal transmitted by a communication calling end to the communication receiving end corresponding to the divert setting by the remote server.

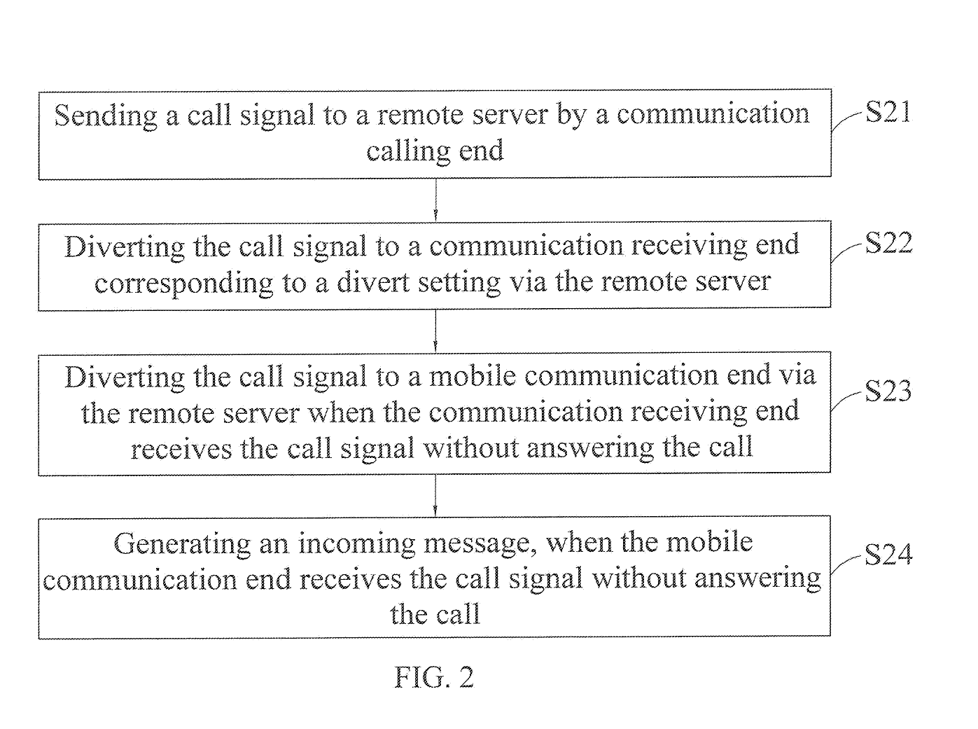

With reference to FIG. 2 for the second flow chart of a positioning and diverting method for mobile communication in accordance with the first preferred embodiment of the present invention, the positioning and diverting method for mobile communication further comprises the following steps:

S21: Sending a call signal to a remote server by a communication calling end.

S22: Diverting the call signal to a communication receiving end corresponding to a divert setting via the remote server.

S23: Diverting the call signal to a mobile communication end via the remote server when the communication receiving end receives the call signal without answering the call.

S24: Generating an incoming message, when the mobile communication end receives the call signal without answering the call.

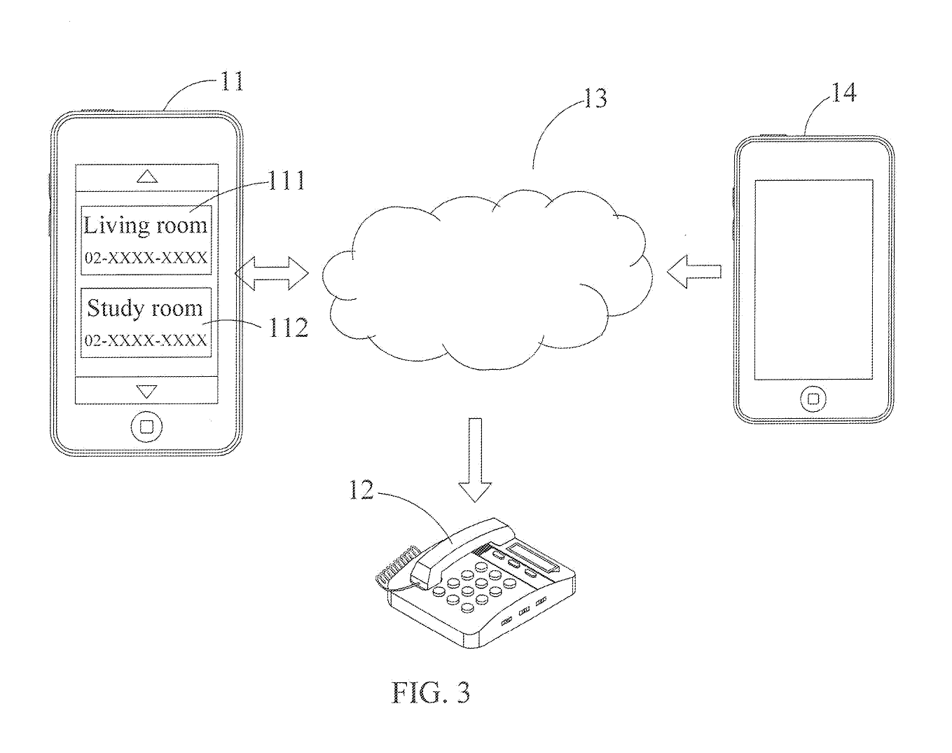

With reference to FIG. 3 for a schematic view of a positioning and diverting method for mobile communication in accordance with the present invention, a user can select a positioning option 112 from a selection interface 111 of a mobile communication end 11, so that the mobile communication end 11 generates a setting signal and send the setting signal to a remote server 13, and the remote server 13 completes a divert setting according to the setting signal. If it is necessary for a communication calling end 14 to send a call signal to the mobile communication end 11 through the remote server 13, the remote server 13 can divert the call signal to the communication receiving end 12 to complete a diverting process.

When the user cannot pick up all incoming calls dialed to the mobile communication end 11 in the condition when the power of the mobile communication end 11 is low, or the user has not carried the mobile communication end 11, or the user borrows the mobile communication end 11 to others, the user can divert all calls dialed to the mobile communication end 11 and receive the calls from a communication receiving end 12 set by the user by means of the positioning and diverting method for mobile communication of the present invention. However, if no one pick up the diverted calls, the calls will be diverted back to the mobile communication end 11. Now, if the calls are still not picked up, the mobile communication end 11 will generate an incoming message (through a screen display or a short message alert) to remind the user about the missed calls. In addition, if no one picks up the calls at the communication receiving end, the incoming message will also be generated.

It is noteworthy to point out that the communication receiving end 12 at a location can be set more than once, and users can set the communication receiving ends 12 at many locations depending on the requirements and situations. In other words, a home phone in the living room and the table PC in the study room can be set as the communication receiving ends at the same time. However, the invention is not limited to such arrangements only. When the remote server 13 diverts a call, the home phone and the tablet PC can receive the call signal simultaneously to issue an incoming call alert (such as a ringtone, a vibration or a combination thereof) to notice the user about the incoming call. By setting the communication receiving ends 12 at more than one location, the rate of missed calls can be reduced effectively.

It is noteworthy that the positioning option 112 of the selection interface 111 of the mobile communication end 11 includes the location of the communication receiving end 12, the number of the communication receiving end 12 or a combination thereof (such as the living room number 02-XXXX-XXXX). The setting signal includes a setting code, the number of the mobile communication end 11, the location of the communication receiving end 12, the number of the communication receiving end 12 or a combination thereof. In addition, the communication mode of the communication calling end 14 and the communication receiving end 12 is telecommunication mode, network communication mode or a combination thereof.

The second preferred embodiment is further provided for illustrating the technical characteristics of the present invention more clearly, the communication mode between the remote server, the communication calling end and the communication receiving end is the network communication mode. However, the present invention is not limited to such communication mode only, but other communication modes can be used instead.

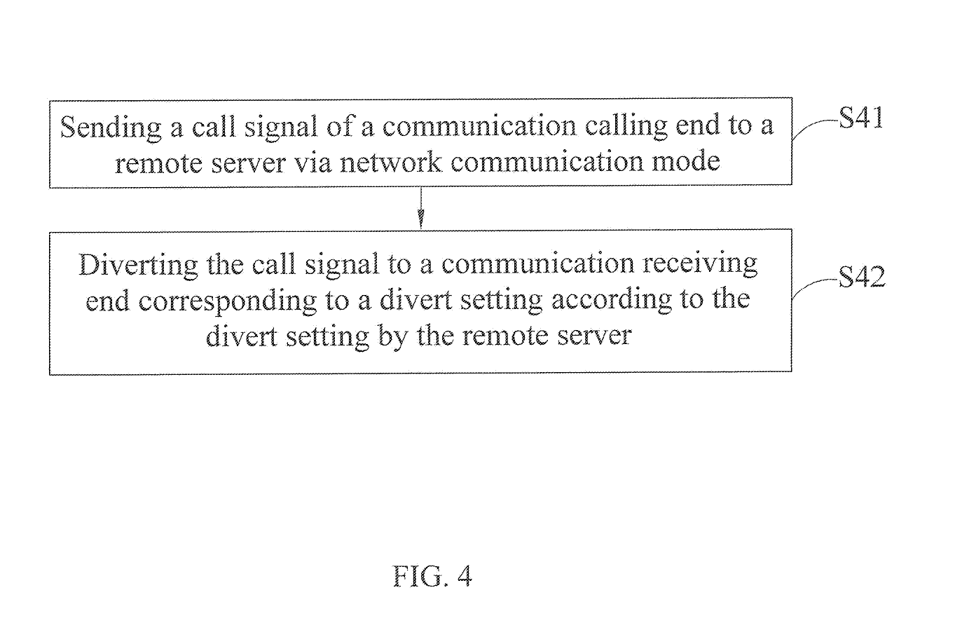

With reference to FIG. 4 for a flow chart of a positioning and diverting method for mobile communication in accordance with the second preferred embodiment of the present invention, the positioning and diverting method for mobile communication of this preferred embodiment differs from that of the first preferred embodiment by further comprising the following steps:

S41: Sending a call signal of a communication calling end to a remote server via network communication mode.

S42: Diverting the call signal to a communication receiving end corresponding to a divert setting according to the divert setting by the remote server.

For example, the mobile phone is the communication calling end; the tablet PC is the communication receiving end; and their communication mode is the network communication mode. The mobile phone calls the mobile communication end via network communication mode, but the user has set the divert function, so that the call signal sent by the mobile phone is diverted to a tablet PC by the remote server, wherein the tablet PC is the communication receiving end set by the user for receiving diverted calls.

The third preferred embodiment is further used as an example for illustrating the invention as follows, wherein the communication mode of the communication receiving end is telecommunication mode, and the communication mode between the mobile communication end, the remote server and the communication calling end is network communication mode. However, these communication modes are used for the purpose of illustrating the invention, but not intended for limiting the scope of the invention.

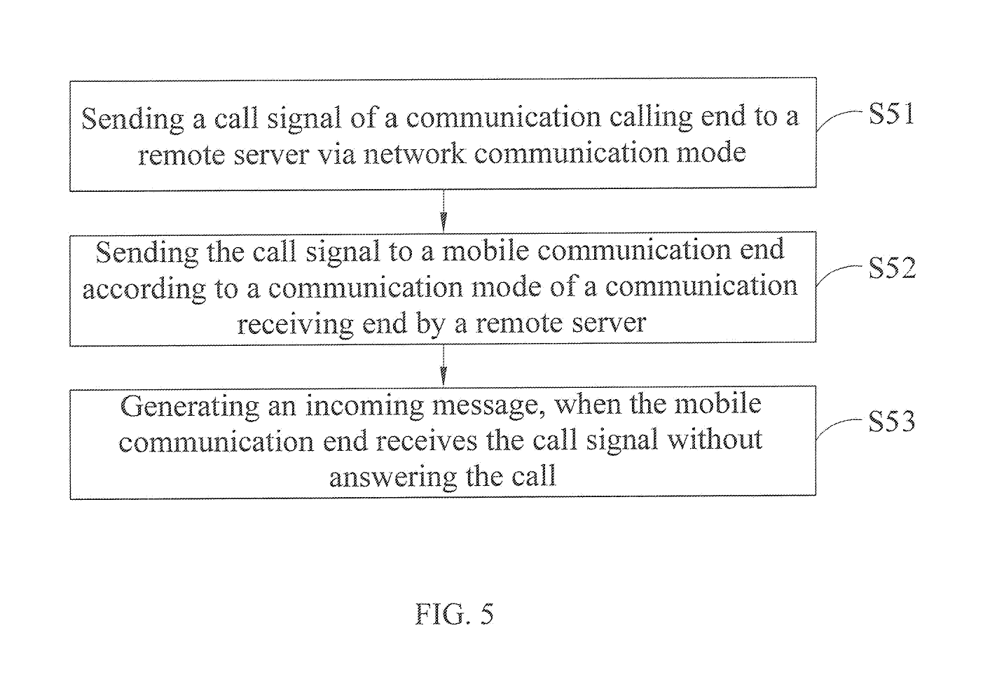

With reference to FIG. 5 for a flow chart of a positioning and diverting method for mobile communication in accordance with the third preferred embodiment of the present invention, the positioning and diverting method for mobile communication of this preferred embodiment differs from that of the first preferred embodiment by further comprising the following steps:

S51: Sending a call signal of a communication calling end to a remote server via network communication mode.

S52: Sending the call signal to a mobile communication end according to a communication mode of a communication receiving end by a remote server.

S53: Generating an incoming message, when the mobile communication end receives the call signal without answering the call.

In the preferred embodiment, the communication receiving end is a home phone or a communication device with a telecommunication function only. Now, if a communication calling end (such as a mobile phone or a tablet PC) wants to communication with a mobile communication end via network communication mode, and the user has set the divert function, the call signal sent by the communication calling end will be diverted from the remote server to the communication receiving end. However, the communication receiving end can just receive the call signal of telecommunication mode, so that the remote server cannot complete diverting the call signal, and the call signal will be diverted to the mobile communication end. If the mobile communication end cannot receive the incoming call, an incoming message (such as a screen display and a short message alert) will be generated. The foregoing example is provided for the purpose of illustrating the present invention only, but not intended for limiting the scope of the invention.

The fourth preferred embodiment is further used as an example for illustrating the invention as follows, wherein the communication mode between the communication calling end, the communication receiving end and the telecommunication server is telecommunication mode, and the communication mode between the mobile communication end and the remote server is network communication mode.

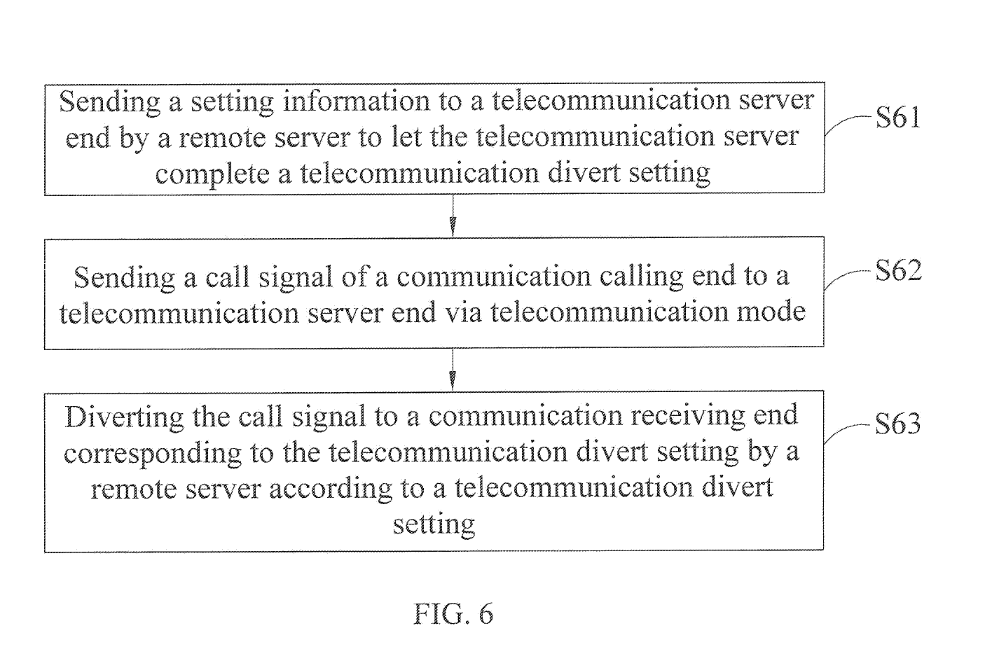

With reference to FIG. 6 for a flow chart of a positioning and diverting method for mobile communication in accordance with the fourth preferred embodiment of the present invention, and the positioning and diverting method for mobile communication of this preferred embodiment differs from that of the first preferred embodiment by further comprising the following steps:

S61: Sending a setting information to a telecommunication server end by a remote server to let the telecommunication server complete a telecommunication divert setting.

S62: Sending a call signal of a communication calling end to a telecommunication server end via telecommunication mode.

S63: Diverting the call signal to a communication receiving end corresponding to the telecommunication divert setting by a remote server according to a telecommunication divert setting.

Wherein, the mobile phone is a communication calling end; the home phone is a communication receiving end and just applicable for telecommunication mode; and the mobile phone communicates with the mobile communication end via telecommunication mode. The user has set the divert function, and the remote server sends a setting information to the telecommunication server, and the telecommunication server completes the telecommunication divert setting according to the setting information, and the telecommunication server diverts the call signal from the mobile phone to the home phone.

The fifth preferred embodiment is further used as an example for illustrating the invention as follows, wherein the communication mode between the mobile communication end, the telecommunication server and the communication calling end is telecommunication mode, and the communication mode between the mobile communication end, the remote server and the communication receiving end is network communication mode.

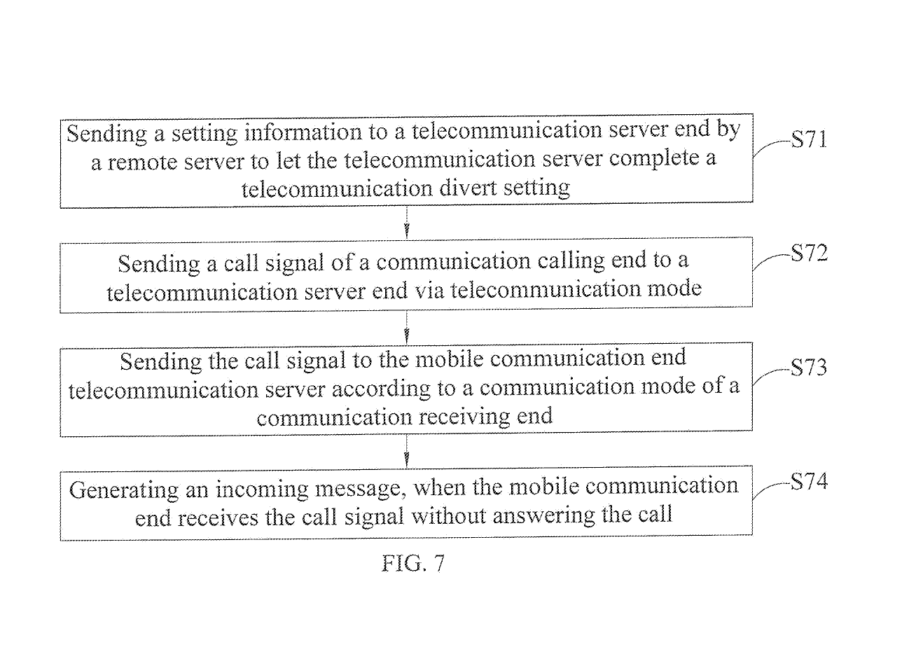

With reference to FIG. 7 for a flow chart of a positioning and diverting method for mobile communication in accordance with the fifth preferred embodiment of the present invention, and the positioning and diverting method for mobile communication of this preferred embodiment differs from that of the first preferred embodiment by further comprising the following steps:

S71: Sending a setting information to a telecommunication server end by a remote server to let the telecommunication server complete a telecommunication divert setting.

S72: Sending a call signal of a communication calling end to a telecommunication server end via telecommunication mode.

S73: Sending the call signal to the mobile communication end telecommunication server according to a communication mode of a communication receiving end.

S74: Generating an incoming message, when the mobile communication end receives the call signal without answering the call.

In this preferred embodiment, the communication receiving end is a communication device capable for network communication mode only. Now, if the communication calling end (such as a mobile phone or a tablet PC) needs to communicate with a mobile communication end via telecommunication mode and the user has set the divert function, the call signal sent from the communication calling end will be diverted to communication receiving end by the telecommunication server. However, the communication receiving end can receive a call signal of network communication mode only, so that the telecommunication server cannot divert the call signal to the communication receiving end, and the remote server will divert the call signal to the mobile communication end. If the mobile communication end cannot receive the incoming call, an incoming message (including a screen display or a short message alert) will be generated.

More specifically, the communication receiving ends as described in the second to fifth preferred embodiments are preferably communication devices of network communication mode and telecommunication mode. Regardless of the call signal diverted via the remote server or the telecommunication server, the communication receiving end can receive the call signal.

The network and telecommunication technologies are prior arts and well known to persons ordinarily skilled in the art, and thus will not be described.

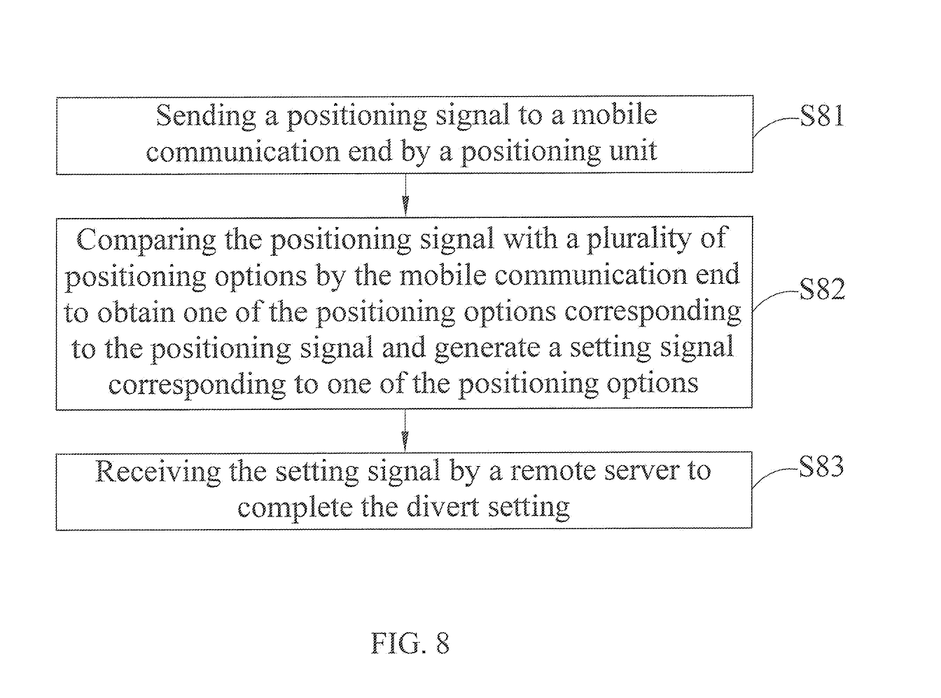

With reference to FIG. 8 for a flow chart of a positioning and diverting method for mobile communication in accordance with the sixth preferred embodiment of the present invention, and the positioning and diverting method for mobile communication of this preferred embodiment further comprises the following steps:

S81: Providing a positioning unit to send a positioning signal to a mobile communication end.

S82: Comparing the positioning signal with a plurality of positioning options by the mobile communication end to obtain one of the positioning options corresponding to the positioning signal and generate a setting signal corresponding to one of the positioning options.

S83: Receiving the setting signal by a remote server to complete the divert setting.

In summation of the description above, users are no longer limited to select the communication receiving end from the selection interface of the mobile communication end. If a user has not carried the mobile communication end, the user still can complete the positioning setting by the positioning unit.

More specifically, the positioning unit positions the location of the user, which is similar to the effect of selecting positioning option (wherein the location corresponding to the positioning option is the location where user can receive a call) from the selection interface. Therefore, regardless of the situation of forgetting or being inconvenient to bring the mobile communication end, all calls dialed to the mobile communication end can be diverted to the location positioned by the positioning unit and the communication receiving end corresponding to the positioning option. In other words, a call can be diverted to a communication device when the communication device is available at the user's location or nearby and the communication mode of the communication device is corresponsive to the communication mode of the communication calling end.

In addition, the positioning unit related technology is a prior art well known to persons ordinarily skied in the art, and thus will not be described in details.

What is claimed is:

1. A positioning and diverting method for mobile communication, comprising the steps of:
providing a mobile communication end having a selection interface, and the selection interface including a plurality of positioning options, each corresponding to a location of a communication receiving end;
selecting at least one of the positioning options by an input unit to generate a setting signal corresponding thereto;
receiving the setting signal by a remote server to through network communication, and the remote server having a database containing a plurality of positioning data;
comparing the plurality of positioning data with the setting signal by the remote server to obtain at least one of the positioning data corresponding to the setting signal and to complete a divert setting; and
diverting a call signal transmitted by a communication calling end to the communication receiving end corresponding to the divert setting by the remote server.

2. The positioning and diverting method for mobile communication according to claim 1, wherein each of the positioning options includes the location of the communication receiving end, a number of the communication receiving end, or a combination thereof.

3. The positioning and diverting method for mobile communication according to claim 1, wherein the setting signal includes a setting code, a number of the mobile communication end, the location of the communication receiving end, the number of the communication receiving end, or a combination thereof.

4. The positioning and diverting method for mobile communication according to claim 1, wherein a communication mode of the communication calling end and the communication receiving end is a telecommunication mode, a network communication mode, or a combination thereof.

5. The positioning and diverting method for mobile communication according to claim 4, wherein the communication mode between the remote server, the communication calling end and the communication receiving end is the network communication mode, and the positioning and diverting method for mobile communication further comprises the steps of:
sending the call signal of the communication calling end to the remote server via the network communication mode; and
diverting the call signal to the communication receiving end corresponding to the divert setting by the remote server according to the divert setting.

6. The positioning and diverting method for mobile communication according to claim 4, wherein the communication mode of the communication receiving end is the telecommunication mode, and the communication mode between the mobile communication end, the remote server and the communication calling end is the network communication mode, and the positioning and diverting method for mobile communication further comprises the steps of:
sending the call signal of the communication calling end to the remote server via the network communication mode;
sending the call signal to the mobile communication end by the remote server according to the communication mode of the communication receiving end; and
generating an incoming message when the mobile communication end receives the call signal without answering the call.

7. The positioning and diverting method for mobile communication according to claim 4, wherein the communication mode between the communication calling end, the communication receiving end and a telecommunication server is the telecommunication mode, and the communication between the mode mobile communication end and the remote server is the network communication mode, and the positioning and diverting method for mobile communication further comprises the following steps:
sending a setting information to the telecommunication server end by the remote server for the telecommunication server to complete a telecommunication divert setting;
sending the call signal of the communication calling end to the telecommunication server end via the telecommunication mode; and
diverting the call signal to the communication receiving end corresponding to the telecommunication divert setting by the remote server according to the telecommunication divert setting.

8. The positioning and diverting method for mobile communication according to claim 4, wherein the communication mode between the mobile communication end, a telecommunication server and the communication calling end is the telecommunication mode, and the communication mode between the mobile communication end, the remote server and the communication receiving end is the network communication mode, and the positioning and diverting method for mobile communication further comprises the steps of:
sending a setting information to the telecommunication server end by the remote server for the telecommunication server to complete a telecommunication divert setting;
sending the call signal of the communication calling end to the telecommunication server end via the telecommunication mode;
sending the call signal to the mobile communication end by the telecommunication server according to the communication mode of the communication receiving end; and
generating an incoming message, when the mobile communication end receives the call signal without answering the call.

9. The positioning and diverting method for mobile communication according to claim 1, further comprising the steps of:
sending a positioning signal to the mobile communication end by a positioning unit;
comparing the positioning signal with the plurality of positioning options through the mobile communication end to obtain one of the positioning options corresponding to the positioning signal and generate the setting signal corresponding to one of the positioning options; and
receiving the setting signal by the remote server to complete the divert setting.

10. The positioning and diverting method for mobile communication according to claim 1, further comprising the steps of:
sending the call signal to the remote server by the communication calling end;
diverting the call signal to the communication receiving end corresponding to the divert setting by the remote server;
diverting the call signal to the mobile communication end by the remote server, when the communication receiving end receives the call signal without answering the call; and
generating an incoming message when the mobile communication end receives the call signal without answering the call.
